(19) United States
(12) Patent Application Publication
(10) Pub. No.: US 2025/0023491 A1
(43) Pub. Date: Jan. 16, 2025

(54) KINETIC ENERGY HARVESTING SYSTEM

(71) Applicant: R2E Enterprises Ltd., Market Rasen (GB)

(72) Inventor: Antony Edmondson-Bennett, Market Rasen (GB)

(73) Assignee: R2E Enterprises Ltd., Market Rasen (GB)

(21) Appl. No.: 18/771,805

(22) Filed: Jul. 12, 2024

(30) Foreign Application Priority Data
Jul. 12, 2023 (GB) 2310235.3
Jan. 9, 2024 (GB) 2400315.4
Jan. 9, 2024 (GB) 2400316.2

(51) Int. Cl. H02N 11/00; E01C 11/00; F03G 7/08

(52) U.S. Cl. CPC H02N 11/002; E01C 11/00; F03G 7/085

(57) ABSTRACT

A road-based energy harvesting system that converts kinetic energy from passing traffic to electricity using a hydraulic motor, powered from a pressurised fluid in a closed circuit, which drives an alternator. The system may have two platforms, operating in a see-saw fashion to transfer torque to compress at least one piston in a cylinder. During a first half cycle the piston performs a high-pressure stroke with a first working hydraulic fluid and during the second half cycle the at least one piston performs a low-pressure stroke with a second working fluid, such as air. The system may include a vehicle recognition system for detecting the mass of an oncoming vehicle and varies the resistance of at least the first piston in a cylinder to optimise energy extraction.

### CROSS-REFERENCE TO RELATED APPLICATIONS

This application claims priority to Great Britain application no. 2310235.3 filed on Jul. 12, 2023, Great Britain application no. 2400315.4 filed on Jan. 9, 2024, and Great Britain application no. 2400316.2 filed on Jan. 9, 2024, the complete disclosures of which, in their entireties, are herein incorporated by reference.

### FIELD OF THE INVENTION

The present invention relates to an energy harvesting system. More particularly, but not exclusively, the present invention relates to a system that converts kinetic energy for example from passing traffic (people or vehicles) to generate electricity.

### BACKGROUND

As global energy demands grow, it is becoming increasingly important to reduce negative impact on the environment and in particular to generate electricity without burning fossil fuels.

Many systems exist to generate energy from renewable sources, including solar panel, wind turbines and hydroelectric turbines. However, such renewable sources have limitations as they are reliant on weather patterns or tides. Therefore, energy is generated only when such renewable resources are available.

Newer electricity generation systems and methods for converting energy exist. These require continuous passage of people or vehicles and generate electricity by converting kinetic energy from mechanical forces and are often referred to as energy harvesting systems.

Many of these energy harvesting systems generate electricity by depression of a platform and pressurising a working fluid and are relatively inefficient.

Other electricity generation systems can have an adverse effect on a vehicle passing over the platform which is especially is undesirable at speed.

Some existing electricity generation systems, which rely on extraction and conversion of kinetic energy, are described below.

### PRIOR ART

United States patent number U.S. Pat. No. 4,739,179 (STITES) discloses a system for generating power by vehicular movement.

United States patent number U.S. Pat. No. 4,081,224 (KRUPP) discloses a series of intermittently operable air pumps.

United States patent number U.S. Pat. No. 4,212,598 (ENERGY DEV CORP) discloses a plurality of actuator members mounted along the surface of a roadway.

Chinese utility model number CN 205154521 (Gao) model provides a ‘piano type’ deceleration strip that can generate electricity.

German patent application DE 102011116180 (Schlegel) discloses an energy conversion plant with piezoelectric materials arranged under road surfaces, railway tracks, or pedestrian walkways.

Korean patent application number KR 20040063875 (Kim Sang Kyoum) discloses an energy generating system that utilises gravity force of a vehicle to generate and accumulate electricity and includes a flywheel for storing kinetic energy.

United States patent application number US 2011/0148121 (Kenney) describes a power generation system comprising a road plate assembly, a rocker arm coupled to the road plate assembly; the rocker arm swinging in a downward manner below the road plate assembly.

United States patent number U.S. Pat. No. 7,315,088 (Erriu) discloses a fluid device for the recovery of the kinetic energy from land vehicles, comprising an intake line, a delivery line, and a pumping unit, and at least one actuating element set along a street or railroad course of an infrastructure for the transit of vehicles.

United States patent number U.S. Pat. No. 5,355,674 (Rosenberg) discloses an installation for generating energy comprising a first swivel plate pivotally mounted within a roadway, a second swivel plate spaced from the roadway, transmission means operatively connecting the first and second swivel plates, and fluid file containers adapted to be compressed.

Korean patent application number KR 20130130290 (Yeong) discloses an electricity generator for installation adjacent a speed bump wherein the speed bump comprises: a body part having an internal hollow portion a rounded upper side, and first and second penetrating parts positioned on either side of a centreline.

A problem has been to optimise energy extracted from vehicles when they pass over the harvesting system. This is particularly difficult as the mass of vehicles varies significantly from a small car to a fully loaded heavy good vehicle (HGVs).

This has entailed using two different lanes, for example, one for smaller vehicles with lower mass and a larger wider lane for heavier vehicles, such as heavy goods, vehicles, (HGV) or articulated trucks or lorries.

The invention overcomes this by providing an improved energy harvesting system that is less likely to be damaged by repeated shock loads and is able to extract greater amounts of kinetic energy than existing systems.

### SUMMARY OF THE INVENTION

According to a first aspect of the present invention that is provided a kinetic energy harvesting system for converting mechanical energy into electrical energy, is adapted to be deployed in a trench in a road or on a road, the system comprises: at least a first and a second displaceable platform, over which a vehicle passes, the platforms are connected one to another by a rigid strut to form a see-saw which is supported by a pivot; during a first half cycle a tyre of a vehicle passing over the first platform depresses the first platform below a neutral line level, thereby pivoting the second platform, to a second position above the neutral line level, and a crank, connected to the see-saw rotates in a first sense (clockwise) and transfers torque, to compress at least a first piston in a cylinder which contains a first working fluid, the first working fluid is fed under pressure to at least one accumulator that functions as a reservoir that stores the first working fluid under pressure, the at least one accumulator is connected to a hydraulic motor which drives an alternator; and during a second half cycle, the tyre of the vehicle passing over the second platform depresses the second platform from above the neutral line level to below the neutral level, and the pivot rotates in an opposite sense (counterclockwise) and transfers torque, to compress the at least one piston in a cylinder, characterised in that a vehicle recognition system detects a characteristic of an oncoming vehicle and varies the resistance of at least the first piston in a cylinder to optimise energy extraction.

The see-saw effect extracts more energy from the energy harvesting system and so improves its efficiency as a tyre passes over two platforms of the energy harvesting system.

According to a second aspect of the present invention that is provided a kinetic energy harvesting system for converting mechanical energy into electrical energy, is adapted to be deployed in a trench in a road or on a road, the system comprises: at least a first and a second displaceable platform, over which a vehicle passes, the platforms are connected one to another by a rigid strut to form a see-saw which is supported by a pivot; during a first half cycle a tyre of a vehicle passing over the first platform depresses the first platform below a neutral line level, thereby pivoting the second platform, to a second position above the neutral line level, and a crank, connected to the see-saw rotates in a first sense (clockwise) and transfers torque, to compress at least a first piston in a cylinder which contains a first working fluid, the first working fluid is fed under pressure to at least one accumulator that functions as a reservoir that stores the first working fluid under pressure, the at least one accumulator is connected to a hydraulic motor which drives an alternator; and during a second half cycle, the tyre of the vehicle passing over the second platform depresses the second platform from above the neutral line level to below the neutral level, and the pivot rotates in an opposite sense (counterclockwise) and transfers torque, to compress the at least one piston in a cylinder, characterised in that a vehicle recognition system detects a characteristic of an oncoming vehicle and varies the resistance of at least the first piston in a cylinder to optimise energy extraction.

In some embodiments the vehicle recognition system determines a mass of the oncoming vehicle using a sensor. Optionally the vehicle recognition system includes an imaging system which determines the size of the oncoming vehicle.

In some embodiments the vehicle recognition system includes an automatic number plate recognition (ANPR) system.

In some embodiments a working fluid is used whose viscosity is variable in order to vary the resistance of the at least first piston in a cylinder in dependence upon the mass of the oncoming vehicle.

In some embodiments a variable throttle which is operative to vary the resistance of the at least first piston in a cylinder.

In another embodiment separate pistons, or groups of pistons, are arranged and are deployed on either a downstroke or an upstroke of the or each platform.

Preferably one or more fluid reservoirs act as accumulators and store the working fluid under pressure.

Optionally a pressure controller which controls a low-pressure valve to open a low-pressure circuit to supply the second working fluid to a low-pressure reservoir which is in fluid communication with a low power hydraulic motor.

Automatic valves are provided in some embodiment in order to oversee controlled release of working fluid form one or more reservoirs (accumulators) to drive one or more alternator(s).

In some embodiments a pressure controller which controls a low-pressure valve to open a low-pressure (air) circuit to supply the second working fluid to a low-pressure reservoir which is in fluid communication with a low power hydraulic motor.

In some embodiments the second working fluid (air) powers a second motor via an expander.

Optionally at least two pistons are arranged together and at least one is deployed on either a downstroke and/or an upstroke of the or each platform. In one such embodiment a bi-directional piston arrangement includes at least one piston in a pair of pistons is arranged to operate on an expansion cycle as an associated piston is operating on a compression cycle.

In some embodiments a control system controls an automatic valve between the reservoir and at least one hydraulic motor or fluid pump or alternator. Preferably the control system receives signals from a remote location via a wireless receiver.

In some embodiments a plurality of sensors is operative to sense system parameters and to send status signals to the control system. In some embodiments the control system transmits status signals and reports to a remote location via a wireless transmitter.

Optionally the sensors are operative to sense system parameters or data including: the number of vehicles passing in a user defined period, vibration levels, temperature and pressure of the working fluid, condition and regularity of moving parts, such as the see-saws. These data can be used to record system efficiency and for predictive maintenance purposes.

Sensors may sense other data such as ambient weather including, moisture (saturation levels) and air temperature.

In some embodiments the alternator of the energy harvesting system is connected to an inverter that feeds current to an electricity supply system or grid or to a battery storage system.

A flywheel (not shown) may be arranged to receive excess energy and stores this temporarily as kinetic energy.

In some embodiments the accumulator includes a plurality of reservoirs arranged as a bank of interconnected modular cassettes, each modular cassette has its own isolation valves which enable a single modular, cassette to be removed from the bank of interconnected modular cassettes.

In some embodiments the modular cassettes are arranged in banks and connected together by one or more common pressure lines. Optionally the modular cassettes are housed in concrete containers. In some embodiments 18 the modular cassettes are connected to a concrete support structure by threaded studs pre-cast therein.

Some embodiments include a means to vary the width of drop of and/or a contact point using a spacer bar strop. An advantage of this feature is that it can be deployed where the RBS is used in regions of heavier (or lighter) traffic and helps reduce damage to the RBS and associated infrastructure.

The resistance to a vehicle is set at a particular force, for example, for a heavy goods vehicles (HGVs), which may not be appropriate for a vehicle of less mass, such as a car or smaller truck.

In some embodiments the vehicle recognition system includes a high-pressure fluid which has a variable rheology so that, for example, a pistons resistance can be increased when a heavier lorry is sensed and reduced for smaller vehicles. This not only improves efficiency of energy extraction but may also reduce damage to infrastructure and the RBS.

According to a third aspect of the present invention that is provided a method of generating electricity using the kinetic energy harvesting system as herein described.

Ideally the method includes the step of recording an instantaneous amount of electrical energy generated and logging a total amount of electrical energy generated during a user defined interval. An advantage of this is that it enables a secure and assured record of so called green to be provided which may be important for audit trails and/or certain types of energy tariffs or billing systems.

In a further aspect, a kinetic energy harvesting system for converting mechanical energy into electrical energy is provided. The system is adapted to be deployed in a trench in a road or on a road, the system comprises: at least a first and a second displaceable platform, over which a vehicle passes, the platforms are connected one to another by a rigid strut to form a see-saw which is supported by a pivot; during a first half cycle a tyre of a vehicle passing over the first platform depresses the first platform below a neutral line level, thereby pivoting the second platform, to a second position above the neutral line level, and a crank, connected to the see-saw rotates in a first sense (clockwise) and transfers torque, to compress at least a first piston in a cylinder which contains a first working fluid, the first working fluid is fed under pressure to at least one accumulator that functions as a reservoir that stores the first working fluid under pressure, the at least one accumulator is connected to a hydraulic motor which drives an alternator; and during a second half cycle, the tyre of the vehicle passing over the second platform depresses the second platform from above the neutral line level to below the neutral level, and the pivot rotates in an opposite sense (counterclockwise) and transfers torque, to compress the at least one piston in a cylinder, characterised in that a vehicle recognition system detects a characteristic of an oncoming vehicle and varies the resistance of at least the first piston in a cylinder to optimise energy extraction.

In embodiments, the vehicle recognition system determines a mass of the oncoming vehicle using a sensor.

In embodiments, the vehicle recognition system includes an automatic number plate recognition (ANPR) system.

In embodiments, the vehicle recognition system includes an imaging system which determines the size of the oncoming vehicle.

In embodiments, the system includes a working fluid whose viscosity is variable in order to vary the resistance of the at least first piston in a cylinder.

In embodiments, the system includes a variable throttle which is operative to vary the resistance of the at least first piston in a cylinder.

In embodiments, the system includes a pressure controller which controls a low-pressure valve to open a low-pressure circuit to supply the second working fluid to a low pressure reservoir which is in fluid communication with a low power hydraulic motor.

In embodiments, the second working fluid (air) powers a second motor via an expander.

In embodiments, at least two pistons are arranged together and at least one is deployed on either a downstroke and/or an upstroke of the or each platform.

In embodiments, the system includes a bi-directional piston arrangement wherein at least one piston in a pair of pistons is arranged to operate on an expansion cycle as an associated piston is operating on a compression cycle.

In embodiments, a control system controls an automatic valve between the reservoir and at least one hydraulic motor or fluid pump or alternator.

In embodiments, the control system receives signals from a remote location via a wireless receiver.

In embodiments, a plurality of sensors is operative to sense system parameters and to send status signals to the control system.

In embodiments, the control system transmits status signals and reports to a remote location via a wireless transmitter.

In embodiments, the sensors are operative to sense system parameters including: numbers of vehicles passing, vibration levels, temperature and pressure of the working fluid, condition and regularity of moving parts, such as see-saws.

In embodiments, the plurality of sensors is operative to sense ambient weather including: moisture (saturation levels) and air temperature.

In embodiments, an inverter receives an output signal from the alternator and feeds current to an electricity supply system.

In embodiments, the system includes a battery storage system to which current is fed from the inverter.

In embodiments, the system includes a flywheel for storing kinetic energy.

In embodiments, the accumulator includes a plurality of reservoirs arranged as a bank of interconnected modular cassettes, each modular cassette has its own isolation valves which enable a single modular, cassette to be removed from the bank of interconnected modular cassettes.

In embodiments, the plurality of modular cassettes is arranged in banks and connected together by one or more common pressure lines.

In embodiments, the modular cassettes are housed in concrete containers.

In embodiments, the modular cassettes are connected to a concrete support structure by threaded studs pre-cast therein.

In embodiments, the system includes a means to vary the width of drop of and contact point using a spacer bar strop.

In one aspect, a method of generating electricity using the kinetic energy harvesting system according to any preceding claim.

In embodiments, the method includes the step of recording an instantaneous amount of electrical energy generated and logging a total amount of electrical energy generated during a user defined interval.

In a yet further aspect, a kinetic energy harvesting system for converting mechanical energy into electrical energy is provided. The system is adapted to be deployed in a trench in a road or on a road, the system comprises: at least a first and a second displaceable platform, over which a vehicle passes, the platforms are connected one to another by a rigid strut to form a see-saw which is supported by a pivot; during a first half cycle a tyre of a vehicle passing over the first platform depresses the first platform below a neutral line level, thereby pivoting the second platform, to a second position above the neutral line level, and a crank, connected to the see-saw rotates in a first sense (clockwise) and transfers torque, to compress at least a first piston in a cylinder which contains a first working fluid, the first working fluid is fed under pressure to at least one accumulator that functions as a reservoir that stores the first working fluid under pressure, the at least one accumulator is connected to a hydraulic motor which drives an alternator; and during a second half cycle, the tyre of the vehicle passing over the second platform depresses the second platform from above the neutral line level to below the neutral level, and the pivot rotates in an opposite sense (counterclockwise) and transfers torque, to compress the at least one piston in a cylinder, characterised in that during the first half cycle the at least one piston performs a high pressure stroke with a first working fluid (hydraulic fluid) and during the second half cycle the at least one piston performs a low pressure stroke with a second working fluid (air).

In embodiments, the system includes a pressure controller which controls a low-pressure valve to open a low-pressure circuit to supply the second working fluid to a low-pressure reservoir which is in fluid communication with a low power hydraulic motor.

In embodiments, the second working fluid (air) powers a second motor via an expander.

In embodiments, at least two pistons are arranged together and at least one is deployed on either a downstroke and/or an upstroke of the or each platform.

In embodiments, the system includes a bi-directional piston arrangement wherein at least one piston in a pair of pistons is arranged to operate on an expansion cycle as an associated piston is operating on a compression cycle.

In embodiments, a control system controls an automatic valve between the reservoir and at least one hydraulic motor or fluid pump or alternator.

In embodiments, the control system receives signals from a remote location via a wireless receiver.

In embodiments, a plurality of sensors is operative to sense system parameters and to send status signals to the control system.

In embodiments, the control system transmits status signals and reports to a remote location via a wireless transmitter.

In embodiments, the sensors are operative to sense system parameters including: numbers of vehicles passing, vibration levels, temperature and pressure of the working fluid, condition and regularity of moving parts, such as see-saws.

In embodiments, the plurality of sensors is operative to sense ambient weather including: moisture (saturation levels) and air temperature.

In embodiments, an inverter receives an output signal from the alternator and feeds current to an electricity supply system.

In embodiments, the system includes a battery storage system to which current is fed from the inverter.

In embodiments, the system includes a flywheel for storing kinetic energy.

In embodiments, the accumulator includes a plurality of reservoirs arranged as a bank of interconnected modular cassettes, each modular cassette has its own isolation valves which enable a single modular, cassette to be removed from the bank of interconnected modular cassettes.

In embodiments, the plurality of modular cassettes is arranged in banks and connected together by one or more common pressure lines.

In embodiments, the modular cassettes are housed in concrete containers.

In embodiments, the modular cassettes are connected to a concrete support structure by threaded studs pre-cast therein.

In embodiments, the system includes a means to vary the width of drop of and contact point using a spacer bar strop.

In embodiments, the system includes a vehicle recognition system which detects a mass of the oncoming vehicle and varies a characteristic of an oncoming vehicle (and thereby determine its weight) and then vary the resistance of the hydraulics to optimise energy extraction.

A preferred embodiment of the invention will now be described, by way of example only, and with reference to the Figures in which:

### BRIEF DESCRIPTION OF FIGURES

FIG. 1 shows an overall diagrammatical view of an energy harvesting system with a double acting piston;

FIGS. 2A and 2B are end elevations of one embodiment of part of an energy harvesting system and show first and second displaceable platforms connected together in a pivoting see-saw configuration with a piston-in-cylinder and connected by way of a crank;

FIG. 3 is a diagrammatic, overall view of another embodiment of an energy harvesting system which stands on supporting feet with impact resistant rubber buffers to cushion impact from the first and second displaceable platforms;

FIG. 4 is a graph of energy (kJ) as a function of pressure (bar) derived from different vehicles passing over the energy harvesting system with results shown in Table 1;

FIG. 5 is a diagrammatical overall view of one embodiment of a kinetic energy harvesting system;

FIG. 6 is a diagrammatic view of an energy harvesting system including a vehicle recognition system including an imager, such as a camera and an ANPR system;

FIG. 7 is an overall diagrammatic view of part of the system in FIG. 6 and illustrates how vehicle data is transmitted within a distributed ledger, for example via a wireless network;

FIG. 8 shows an overall view of one embodiment of a torque arm and piston assembly;

FIG. 9 is an overall view of one example of a high pressure and low-pressure storage fluid storage device;

FIG. 10 shows an overall view of a continuous drive shaft used to support platforms of the energy harvesting system; and

FIG. 11 are diagrams showing the relationship between shrink disc and cone clamp hubs which are components of the energy harvesting system.

### DETAILED DESCRIPTION OF A PREFERRED EMBODIMENTS OF THE INVENTION

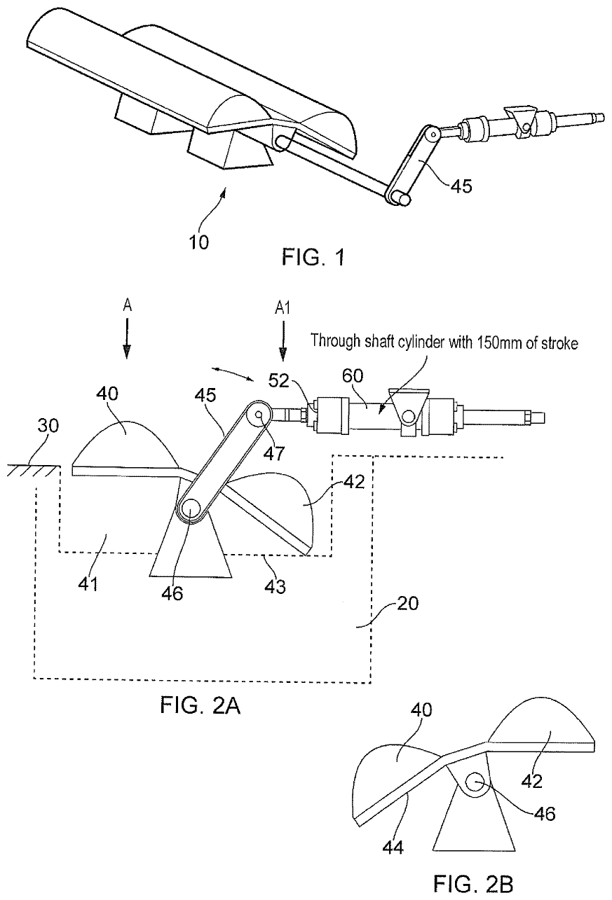

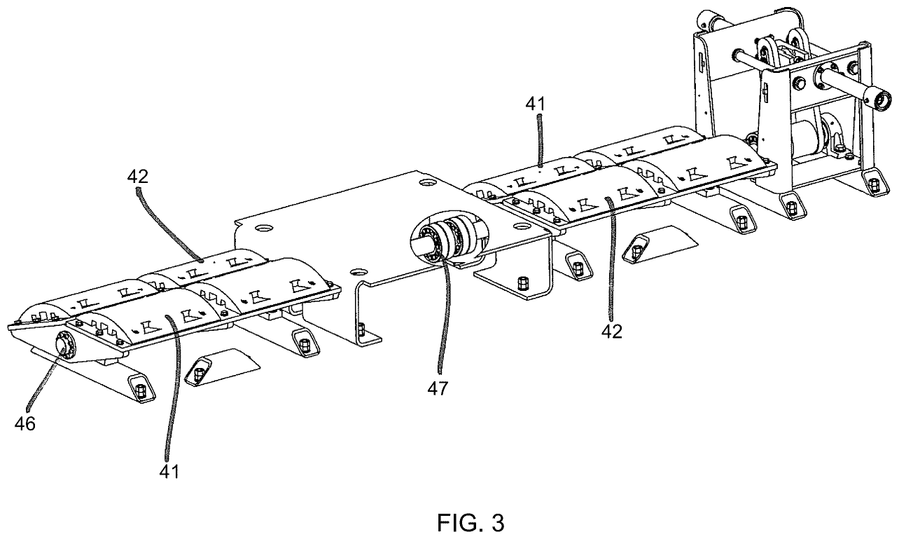

Referring to the Figures and Table 1, FIG. 1 shows a diagrammatical view of a double acting piston energy harvesting system 10 for converting mechanical energy into electrical energy. System 10 is adapted to be deployed in a trench 20 in a road or track 30.

The energy harvesting system 10 comprises: at least a first 40 and a second 42 displaceable platforms, over which a vehicle, indicated by arrows A and A′ passes. The displaceable platforms 40, 42 are connected one to another by a rigid strut 44 to form a see-saw (FIG. 2B) which is supported by a pivot 46.

During a first half cycle a tyre of the vehicle passes over the first platform 40 to depress it below a road surface level, into a first void 41, thereby pivoting the second platform 42, from a second void 43 to a position above the road surface level. A crank 45, which is connected to the pivot 46, rotates in a first sense (clockwise) and transfers torque, from the pivot, to compress at least one piston 52 in a cylinder 54 which contains a working fluid which drives an alternator 68.

During a second half cycle, the tyre (not shown) of the vehicle passes over the second platform 42 to depress it below a road surface level, into the second void 43, thereby pivoting the first platform 40 upwards and out of the first void 41 to a position above the road surface level. As this occurs pivot 46 rotates in an opposite sense (counterclockwise) and transfers torque to drive piston 52 in an opposite direction in cylinder 60.

It is appreciated that the double acting piston 52 may be replaced by one or more pairs of single acting pistons which may be arranged on yokes (not shown) or in banks or in other configurations in order to improve efficiency and facilitate repair.

In one embodiment a piston stroke is between 100 mm and 200 mm, preferably the stroke is substantially 150 mm.

The amount of energy generated can be varied for example by reducing or extending the length of the see-saw and the spacing between the first and second displaceable platforms 40, 42.

Optionally the amount of flow of working fluid can be increased or reduced by raising or lowering the pitch of the see-saw (FIG. 2B); that is the height to which each of the displaceable platforms rise above ground level. Similar variation of output power can be reproduced by extending or shortening the crank 45. By varying these characteristics, it is understood that the size, power output and efficiency of the energy harvesting system 10 is able to be customised for various types of traffic flows and makes the system modular.

Referring to FIG. 2, which shows an embodiment of an energy harvesting system which stands on supporting feet with impact resistant rubber buffers mounted on pillow blocks which cushion impact of support struts 44 on which the displaceable platforms 40, 42 are mounted. Struts and support feet are ideally formed form steel or stainless-steel section depending upon the location. Groups of displaceable platforms may be connected one to another by mounting them on a common shaft 46 which acts as the pivot.

Kinetic energy is transferred via crank arm 45 which is protected with a shrink disc 47 to prevent damage to the piston 60. The pistons are fitted with a series of check valves (not shown) which allow both flow and return of a hydraulic working fluid into the system.

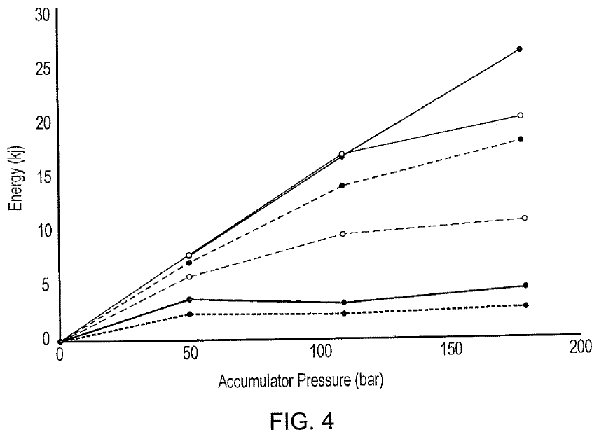

The graph in FIG. 4 (and Table 1) shows examples of energy recovery for each vehicle that transitions over the energy harvesting system 10. The examples are based upon the mass and speed of the vehicle. In the examples shows it is apparent that the system 10 can generate in excess of 25 kJ for each heavy goods vehicle (HGV) and a torque through the shaft in excess of 28 KN/m.

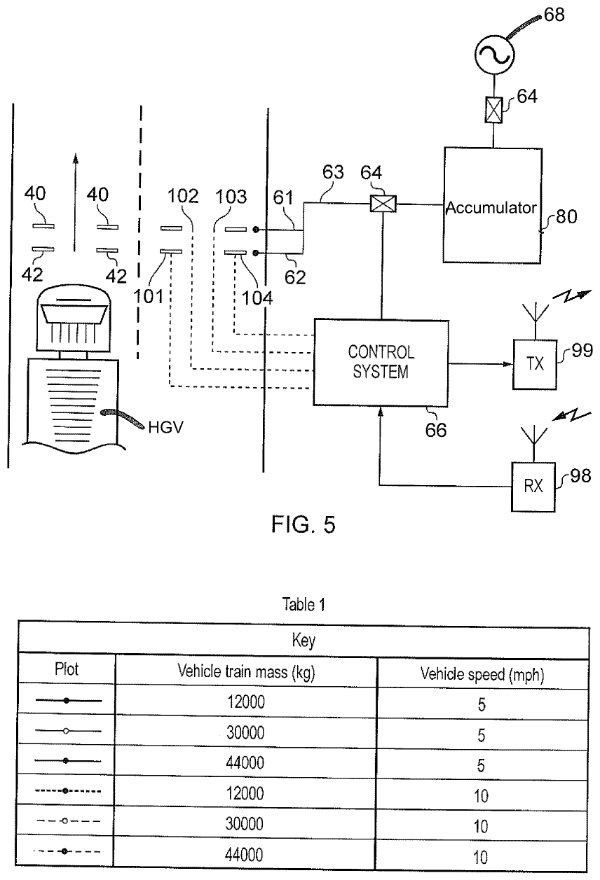

Referring to FIG. 5 which shows a diagrammatical overall view of the system 10 when installed in a road and with fluid lines 61 and 62 from piston 60 connected to a common pressure input line 63 which in turn is connected to an accumulator 80 in which pressurised working fluid is stored.

Alternatively, accumulator 80 may be provided in the form of modular cassettes (not shown) arranged in banks and optionally connected by one or more common pressure lines (not shown). Automatic valve 64 is controlled by a control system 66 which may also be used to control banks of reservoirs. Controller 66 is also connected to a receiver 98 and a transmitter 99 for communication, with remote locations and in order to receive updates and control data as well as enabling status reports to be transmitted.

The modular cassettes (not shown) may be mounted in various ways in order to secure the cassettes and enable rapid removal for repair and replacement.

The pistons 60 are ideally mounted above ground to allow for simple maintenance and to prevent the ingress of dirt and other extraneous materials. This also ensures that all pressure lines and hydraulic parts are located and housed above ground and away from moving parts, such as the displaceable platforms 40, 42 to avoid any vehicles having to drive over them.

The cassettes (not shown) are ideally connected via a manifold pipe of rigid construction which prevents pressure loss due to the flexing of the outer wall which would occur in flexible connections.

The working fluid is captured in the energy harvesting system 10. The energy harvesting system 10 consists of a modular unit which is designed to take various sizes and pressure rated accumulators or a reservoir 80 which are controlled by control system 66. The control system 66 determines when the reservoir (or banks of accumulators) is filled and emptied to power a hydraulic motor which in turn drives the alternator 68.

An hydraulic motor drives the alternator 68 is fed via a pressure regulated line, via valve 64, in order to provide a constant flow of hydraulic fluid at a sufficiently high pressure to drive the alternator 68. The hydraulic motor drives alternator or generator 68 which has been sized for the application. Output of the generator 68 is fed directly into an inverter (not shown) which is connected to be fed directly to an electricity grid or into a battery storage system (not shown).

In a particularly preferred embodiment return springs for pistons are removed and replaced with a bi-directional piston arrangement consisting of a pair of pistons. In this bi-directional piston arrangement, a first piston, on a compression cycle, opens (or withdraws) a second piston, through its expansion cycle in readiness for the subsequent compression of the second piston and retraction of the first piston. This alternating motion occurs in connected pairs of pistons, which are each connected to an opposite end of the aforementioned see-saw. The bi-directional piston arrangement ensures that the piston that is compressing causes or creates an area of low pressure in its related piston, which facilitates the refilling of the piston with oil, ready for the next stroke.

Sensors 101, 102, 103 and 104 are provided for monitoring local weather and environmental conditions, levels of traffic system parameters such as vibration levels, pressure of working fluid, regularity of movement of see-saws, and temperature. The control system 66 received signal from the sensors 101, 102, 103 and 104 which measure all the parameters of the system to enable the preparation of status report.

The control system 66 also determines when valves 64 and other operational devices are activated or deployed to operate.

A system controller 66 advantageously includes monitoring equipment for monitoring local system parameters as well as servos controllers for controlling valves and pressure lines and sends and receives data via a 4G/5G receiver 98 and transmitter 99 or a Wi-Fi mesh system in regions lacking a 4G/5G signal.

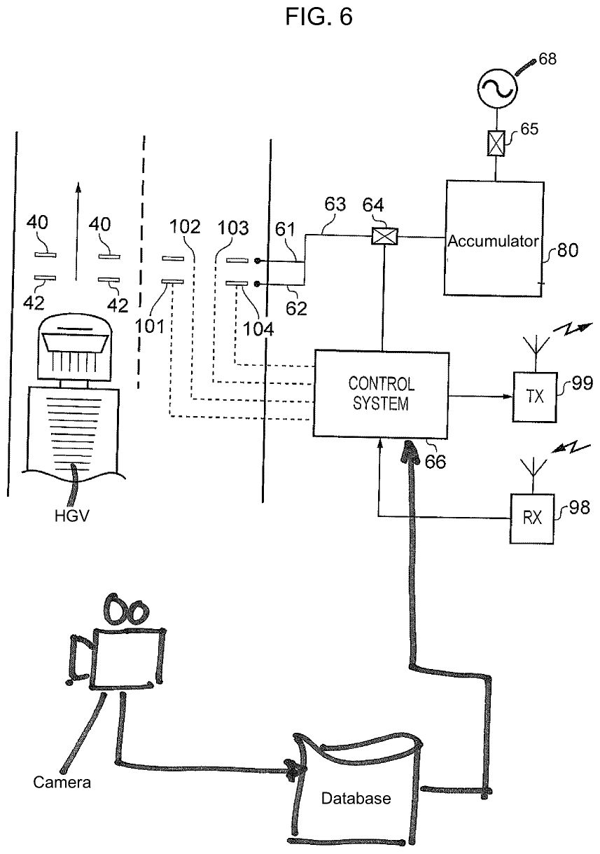

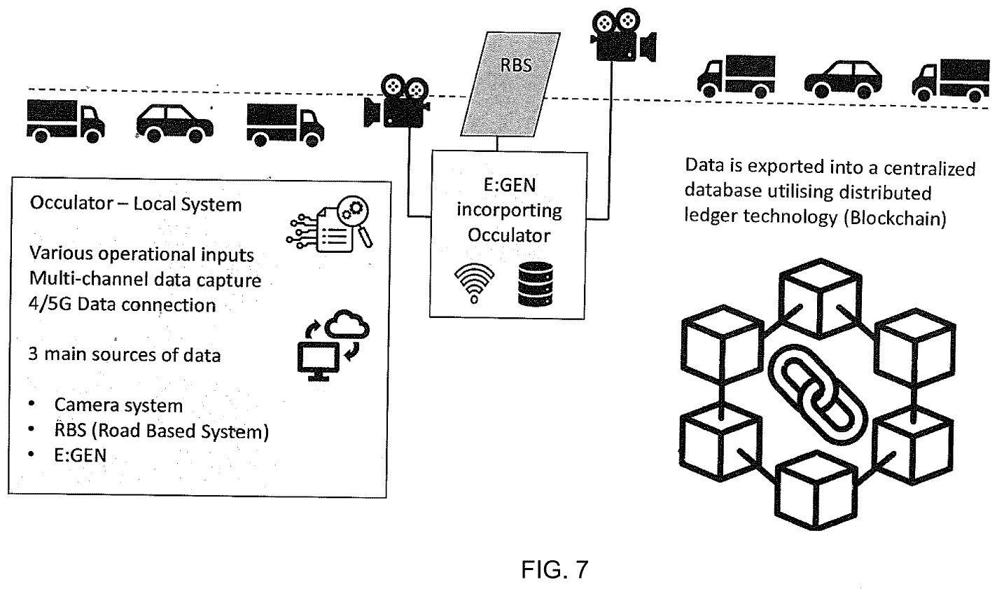

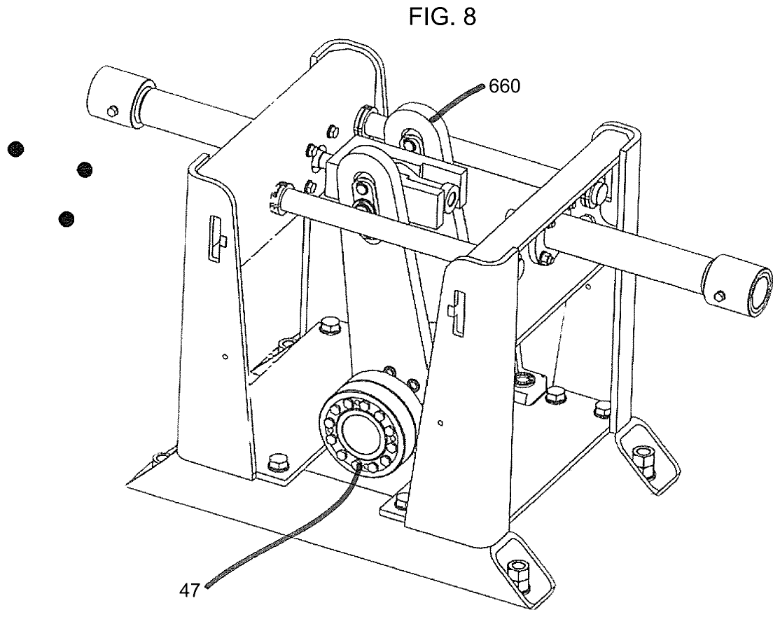

Referring to FIGS. 6 and 7 there can be extremely high loads and shock forces associated, for example with a 44-tonne loaded truck or heavy goods vehicle (HGV), as it passes over the kinetic energy harvesting system. When such kinetic energy harvesting systems are mounted in a trench in a road they are referred to as a road-based system (RBS). It is important to ensure the RBS has strength and in specific places also rigidity, to cope with these dynamic loads.

Depending on which aspect of the RBS is being considered, design has been based on an 8500 kg axle weight because this is the highest axle weight permitted for a standard load on UK roads. It is appreciated that larger loads may be encountered in which case appropriate revision of component sizes and load tolerances may be necessary.

Other specifications may also be appropriate, for example if deriving maximum expected torque in a system based on force exerted from each hydraulic piston 640. However, the force from a hydraulic piston 640 is dependent on its size, capacity, length of stroke and fluid pressure. All these may be varied to suit a specific application. Additionally, the length of crank arm 650 also has an effect on output torque through the RBS drive shaft; this can of course also be varied.

It is also important to note that due to the very high forces in the system, it is not always possible to consider strains or displacements as being negligibly small and therefore additional safety factors and appropriate tolerances must be considered as explained below. For example, in some instances, if deflections are high, components may impact on fixed, or end stops or other components and in which case damage or sub-optimal performance can occur. It is therefore essential to ensure that if such events could occur, they may have an impact on forces or torques transmitted through the system.

Some of these issues and examples of steps taken to mitigate them are explained briefly below.

Each platform has a series of dynamic loads applied to then from the axles of vehicles passing thereover. The load transfer through each. For the purposes of this description, it is important to note twist occurs in each RBS platform.

To better understand the deflections of the whole RBS assembly it was considered useful to model a simplified version of the assembly.

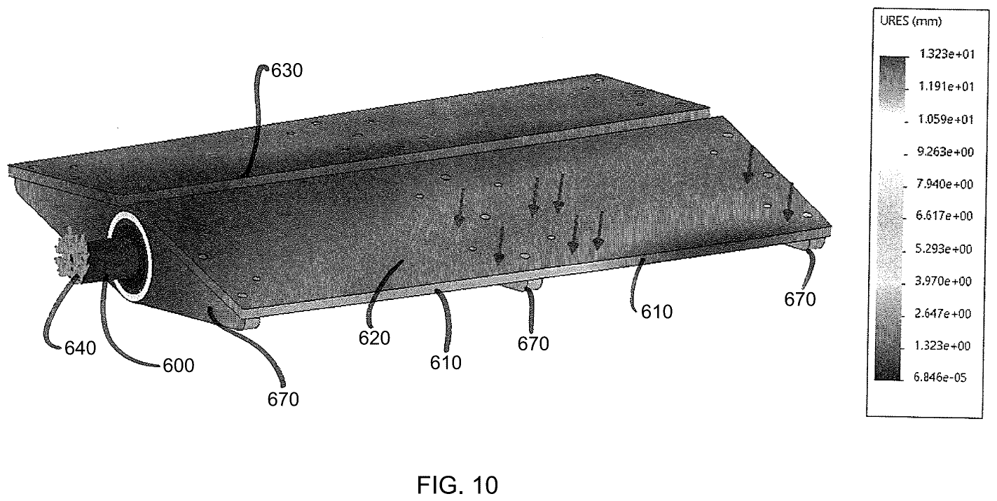

FIG. 10 is a simplified overview of one example of a kinetic energy harvesting system and is particularly useful for modelling expected twist in the assembly when loaded.

FIG. 10 shows a continuous drive shaft 600 being modelled with an increase in thickness around region 610 corresponding to coupling between each of the two platforms 620 and 630 of the RBS.

The end of the crank arm is cut-off to provide a planar surface where a boundary condition can be applied for the force from the hydraulic pistons.

These simplifications provide an approximately equivalent stiffness while keeping the complexity of the simulation as low as possible.

The sections of the shaft corresponding to the five pillow block bearings, as shown in FIG. 10, are constrained from radial movement by the simulation parameters. A cut-off planar section of the simplified crank arm is constrained from in-plane movement by the simulation parameters.

Component interactions are briefly discussed below and with reference to FIG. 10.

Any components that may come into direct contact with one another, such as road plates 665 with support ribs 660, are bonded together at their interface. The bolted interface in reality is slightly less stiff, but this is a reasonable approximation of the bolted joint.

The interface between each of the support ribs 670 and the drive shaft is rigidly constrained to prevent any relative movement. This is a good approximation of the shrink disc and cone clamp hubs which is very rigid.

By applying a load centrally on the RBS, evenly distributed between two contact patches 640 mm×177 mm. This load in this position equates to a cylinder force of 35 kN which is the force in a 50 mm diameter piston with a fluid pressure of 180 bar.

This simulation shows a deflection, in particular in the RBS section furthest from the hydraulic cylinders. Due to parts of the right-hand side RBS deflecting the RBS side may contact the end stop before the left-hand side.
600 drive shaft
610 region of increased thickness
620 first platform
630 second platform
640 Shrink disc
665 road plates
670 support ribs

FIG. 10 also indicates, as a grey scale, where the magnitude of deflections when a distributed load is applied to the assembly.

If part of an RBS contacts its end-stop, it is no longer be able to transmit torque to the hydraulic piston in cylinder as at least a portion of the load is supported by the reaction force from the end-stop. This could in due course mean that there is no-longer sufficient torque in the system to overcome inherent accumulator pressure and could result in decreases in fluid pumping. The range of travel at the tip of a road plate 665 is 148 mm. A 30 mm tip deflection is 20% of the range of travel; this could mean a consequential of up to 20% reduction in the travel of the hydraulic piston and a corresponding reduction in the energy harvested from the vehicle.

Whether or not this occurs depends on the vehicle speed and suspension characteristics. For example, an anti-roll bar transfers force into the higher of two wheels (i.e. where there is less deflection in the RBS) and therefore mean the RBS half that is least stiff, may experience a lower load.

It is also possible to extract the torque transmitted through each hub interface.

As the shaft coupling is not explicitly modelled the torque through this is not extracted from the simulation but can be calculated from the sum of torques from either side of the system. This gives a torque through the coupling of 6.7 kNm.

The torque calculated here differs from those mentioned above, because the load is applied centrally to the RBS in this analysis, and also the load applied is calculated backwards from the piston force from a 50 mm diameter piston at 180 bar, rather than based on an axle load applied to the RBS assembly.

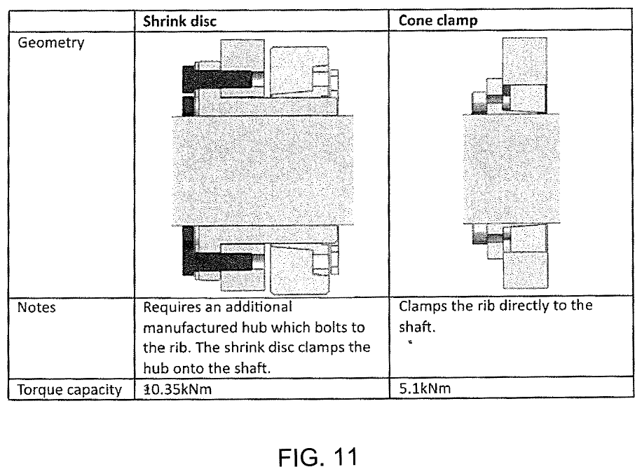

FIGS. 11A and 11B show examples of the torque carrying capacity of both shrink discs and cone-clamping hubs. This also provides a brief analysis that justifies component selection on each RBS half. By applying a force that corresponds to the piston force rather than the axle weight, the torques are lower and in this instance indicate that only a single shrink disc (shown in FIG. 11B) is required on the shaft coupling, however in certain circumstances twin shrink discs may be utilised.

Referring to FIG. 6 there is shown a diagrammatic view of a system including a vehicle recognition system 500 which includes a processor 502. Referring briefly to FIG. 7, there is shown in diagrammatic form an example of the vehicle recognition system, such as an automatic number plate recognition (ANPR) device. This determines what type of oncoming vehicle is approaching the energy extraction system and its weight. Alternatively one or more weighbridges may be used. FIG. 7 shows how this vehicle data is transmitted, for example from ANPR device, such as a camera, via a distributed digital ledger, for example via a wireless network to obtain vehicle data.

A control signal is derived by a control system, shown in FIG. 6, and is sent to valve 64 which is adjusted in dependence of the mass of the oncoming vehicle. This varies the resistance of at least one of the piston in a cylinders to optimise energy extraction.

FIG. 8 shows the torque arm and piston assembly. Shrink disc 47 is shown on this Figure along with torque arm 660 also known as the crank arm. FIG. 8 also shows a single crank arm 660 of double thickness. The crank arm hub has high torsional stiffness by design to promote equal load sharing between the two crank arms. The crank arm 660 is placed in the position of the right-hand crank arm and closest to the shrink discs.

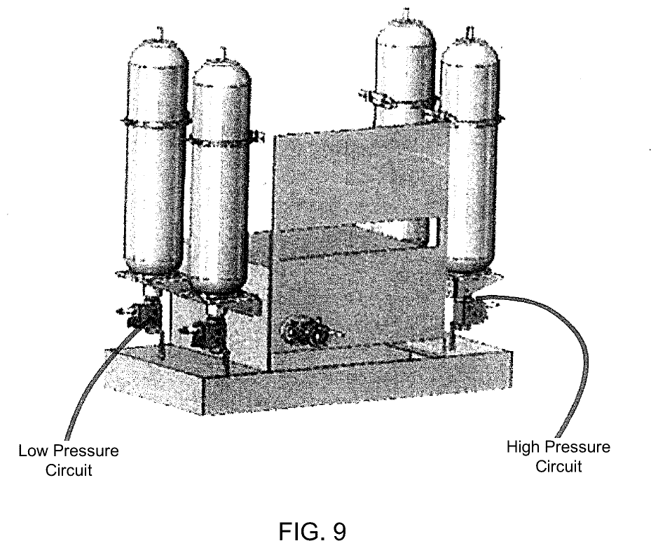

FIG. 9 is an overall view of one example of a high- and low-pressure system showing the position of the accumulators.

The invention has been described by way of examples only and it will be appreciated that variation may be made to the embodiments described, without departing from the scope of the invention as defined by the claims.

What is claimed is:

1. A kinetic energy harvesting system for converting mechanical energy into electrical energy, is adapted to be deployed in a trench in a road or track, the system comprises: at least a first and a second displaceable platform, over which a vehicle passes, the platforms are connected one to another by a rigid strut to form a see-saw which is supported by a pivot; during a first half cycle a tyre of the vehicle passes over the first platform to depress it below a road surface level, into a first void, thereby pivoting the second platform, from a second void to a position above the road surface level, and a crank, which is connected to the pivot, rotates in a first sense (clockwise) and transfers torque, from the pivot, to compress at least one piston in a cylinder which contains a working fluid which for driving an alternator; and during a second half cycle, the tyre of the vehicle passes over the second platform to depress it below a road surface level, into the second void, thereby pivoting the first platform, from the first void to a position above the road surface level, and the pivot rotates in an opposite sense (counterclockwise) and transfers torque from the pivot, to compress the at least one piston in a cylinder.

2. The kinetic energy harvesting system according to claim 1, comprising a hydraulic motor connected to the alternator.

3. The kinetic energy harvesting system according to claim 1, wherein at least two pistons are arranged together and at least one is deployed on either a downstroke or an upstroke of the or each platform.

4. The kinetic energy harvesting system according to claim 3, comprising a bi-directional piston arrangement wherein at least one pistons in a pair of pistons is arranged to operate on an expansion cycle as an associated piston is operating on a compression cycle.

5. The kinetic energy harvesting system according to claim 1, wherein one or more fluid accumulators function as a reservoir to store the working fluid under pressure.

6. The kinetic energy harvesting system according to claim 1, wherein a control system controls an automatic valve between the reservoir and at least one hydraulic motor or fluid pump or alternator.

7. The kinetic energy harvesting system according to claim 6, wherein the control system receives signals from a remote location via a wireless receiver.

8. The kinetic energy harvesting system according to claim 1, wherein a plurality of sensors are operative to sense system parameters and to send status signals to the control system.

9. The kinetic energy harvesting system according to claim 1, wherein the control system transmits status signals and reports to a remote location via a wireless transmitter.

10. The kinetic energy harvesting system according to claim 9, wherein sensors are operative to sense system parameters including: numbers of vehicles passing, vibration levels, temperature and pressure of the working fluid, condition and regularity of moving parts, such as see-saws.

11. The kinetic energy harvesting system according to claim 1, wherein a plurality of sensors are operative to sense ambient weather including: moisture (saturation levels) and air temperature.

12. The kinetic energy harvesting system according to claim 1, wherein an inverter receives an output from the alternator and feed current to an electricity supply system.

13. The kinetic energy harvesting system according to claim 12, comprising a battery storage system to which current is fed from the inverter.

14. The kinetic energy harvesting system according to claim 5, wherein the reservoir comprises a plurality of modular cassette arranged as a bank of interconnected modular cassettes, each modular cassette has its own isolation valves which enables a single modular cassette to be removed from the bank of interconnected modular cassettes.

15. The kinetic energy harvesting system according to claim 14, wherein the modular cassettes are arranged in banks and connected together by one or more common pressure lines.

16. The kinetic energy harvesting system according to claim 14, wherein banks of modular cassettes are housed in concrete containers.

17. The kinetic energy harvesting system according to claim 16, wherein modular cassettes are connected to a concrete support structure by threaded studs pre-cast therein.

18. A method of generating electricity using the kinetic energy harvesting system according to claim 1.

19. The method according to claim 18, comprising recording an instantaneous amount of electrical energy generated and logging a total amount of electrical energy generated during a user defined interval.
